(19) United States
(12) Patent Application Publication
(10) Pub. No.: US 2012/0209664 A1
(43) Pub. Date: Aug. 16, 2012

(54) SYSTEMS AND METHODS FOR PROCESSING TRANSACTIONAL DATA

(75) Inventors: Keith Cleland, Armidale (AU); Trevor Watters, Frenchs Forest (AU)

(73) Assignees: WESLEY ENTERPRISES PTY LTD, Frenchs Forest, New South Wales (AU); LIDOLO PTY LTD, Armidale, New South Wales (AU)

(21) Appl. No.: 13/499,019

(22) PCT Filed: Sep. 30, 2010
(86) PCT No.: PCT/AU10/01287

§ 371 Date: May 1, 2012

(30) Foreign Application Priority Data
Sep. 30, 2009 (AU) 2009904771

(51) Int. Cl. G06Q 10/06

(52) U.S. Cl. 705/7.39

(57) ABSTRACT

Systems and methods for processing transactional data. One embodiment provides a method including receiving data indicative of one or more past or current business transactions prior to finalization of one or more current or future transactions. The data is processed to derive individual or accumulative transactional assessment indicative of the profitability of the transaction(s). The method compares the transaction(s) assessment with a predefined benchmark to selectively raise an alert. This allows modification of the current business transaction(s) either prior or subsequent to the finalization of the transaction(s), in order to better align with the predefined benchmark. In one embodiment, when a request for a quote or price is made, the transactional data is processed to estimate the profitability of the transaction and is compared with a predetermined target profit for the transaction. Depending on how the comparison with the target data, immediate action may be taken to improve the transaction.

### FIELD OF THE INVENTION

The present invention relates to systems and methods for processing transactional data, and more particularly to computer implemented technologies for monitoring and improving the profitability of a business.

Embodiments of the invention have been particularly developed for collecting and processing business transactional data and comparing this data with a benchmark to rank and subsequently allow modification of business transaction(s) prior to finalisation of one or more transaction(s). While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Current accounting and related software methodology is excellent for providing a retrospective view as to the performance of a business. For example, reports are able to be generated, thereby allowing retrospective analysis of profitability and the like. This retrospective form of analysis can prove problematic, in the sense that issues (such as less than ideal sales practices) are often noticed too late for them to be adequately addressed. For example small deficiencies in a number of quotes, prices or invoices can multiply exponentially over days and weeks with the potential to seriously erode profitability.

### SUMMARY OF THE INVENTION

It is an object of the present invention to overcome or ameliorate at least one of the disadvantages of the prior art, or to provide a useful alternative.

One embodiment of the invention provides a method of processing transactional data, including the steps of:

receiving transactional data indicative of a business transaction prior to finalisation of that transaction;

processing the data thereby to derive transactional assessment information indicative of the profitability of the business transaction;

comparing said transactional assessment information with a predefined benchmark; and

based on the comparison of said transactional assessment information with said predefined benchmark, selectively raising an alert, thereby to allow modification of said transactional data such that an opportunity is provided to better align with the predefined benchmark.

The transactional data preferably includes total sale price of a business activity, total direct costs associated with producing said business activity, number of units of said business activity and time and date of the transaction.

In one embodiment the transactional assessment information preferably includes the gross profit per unit of activity. In an alternative embodiment the transactional assessment information preferably includes the gross profit percentage in combination with gross profit per unit of activity.

The benchmark is preferably calculated using past transactional data. In one embodiment the benchmark is preferably a projection or financial budget calculated based on an estimate of the average gross profit per unit and/or an estimate number of units. In an alternative embodiment the benchmark is preferably the ‘target average gross profit per unit of activity’. In a further alternative embodiment the benchmark is preferably the target number of activity units sold. In another embodiment the benchmark is preferably the actual gross profit per unit achieved for any past period.

Comparing the transactional assessment information with the predefined benchmark preferably includes measuring the degree to which the transaction assessment data is above or below the benchmark.

The transaction is preferably ranked based on the degree to which the transaction assessment data is above or below the benchmark.

In one embodiment the alert is preferably received both at the point of transaction by a staff member responsible for the transaction and additionally at a management level. In an alternative embodiment the alert is only received by a staff member responsible for the transaction. In this embodiment the alert is preferably displayed on a computer screen visible to the staff member. Preferably the alert provides recommendations on available options for improving the transaction.

A second embodiment of the invention provides a computer system including a processor configured to perform a method as discussed herein.

A third embodiment of the invention provides a computer program product configured to perform a method as discussed herein.

A fourth embodiment of the invention provides a computer readable medium carrying a set of instructions that when executed by one or more processors cause the one or more processors to perform a method as discussed herein.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 illustrates a method according to one embodiment.

FIG. 2 illustrates a system according to one embodiment.

### DETAILED DESCRIPTION

Described herein are systems and methods for processing transactional data. One embodiment provides a method including receiving data indicative of one or more business transactions prior to finalisation of those transactions. The data is then processed thereby to derive transactional assessment information indicative of the profitability of the business transaction(s). The method further includes comparing the transactional assessment information with a predefined benchmark. Based on the comparison of the transactional assessment information with the predefined benchmark, an alert is selectively raised. This allows modification of business transaction(s), such that an opportunity is provided to better align with the predefined benchmark. For example, in one embodiment, when a request for a quote or price is made, the transactional data is processed to estimate the profitability of the transaction and is compared with a predetermined target profit for the transaction. Depending on how the transaction compares with the target data, immediate action may be taken to improve the transaction, or an alert may be forwarded to management to make a transaction decision by reference to a year-to-date comparison of actual with target. Such action may include increasing or decreasing the price of the transaction.

Throughout this specification the term ‘business activity’ or simply ‘activity’ is used to describe the underlying products or services provided by a business, branch or department and used to drive output that business. For example, in manufacturing, trade or service industries, a unit of business activity can be a production hour, in retailing; a sale, and in restaurants; a meal.

Throughout this specification, unless specifically stated otherwise, the term ‘unit’ or ‘units’ refers to the measurement of a business activity outlined above. For example, in a professional industry; an hour of professional time might constitute a unit of activity.

Throughout this specification the terms ‘business transaction’ or simply ‘transaction’ are used to describe business transactions in a broad sense. In general terms, a transaction involves the immediate, proposed or future exchange of finances. More specifically, a transaction is an event where goods or services are quoted, proposed or sold for a consideration. Examples of business transactions include quotations, cost estimates, proposals to undertake work, invoices, and the like.

Throughout this specification, unless specifically stated otherwise, the term “direct costs” refers to costs of goods/materials used. This excludes operational expenses such as wages/salaries, rent, insurance, telephone and so forth, which are treated as indirect along with expenses related to finance and administration.

Throughout this specification, unless specifically stated otherwise, the term “transactional data” consists of at least a sale value, direct costs and units of activity for one or more transactions.

Throughout this specification, unless specifically stated otherwise, the term “gross profit” refers to sales less cost (cost of goods/materials used plus outsourced or subcontracted work), or total operating expenses plus net profit or number of units invoiced multiplied by the average gross profit per unit.

### Method Overview

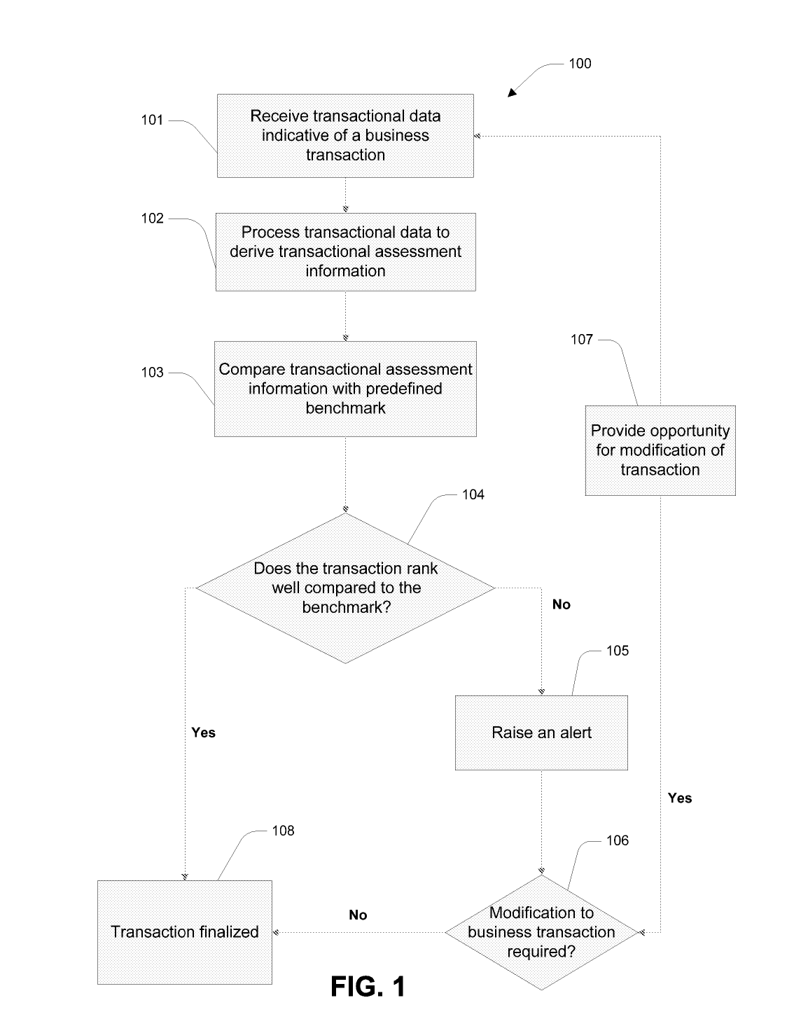

Referring initially to FIG. 1, one embodiment provides a method 100 of processing transactional data. This method includes, at block 101, receiving data indicative of one or more business transactions prior to finalisation of those transactions. The data is then processed at block 102 thereby to derive transactional assessment information indicative of the profitability of the business transaction. The method further includes, at block 103, comparing the transactional assessment information with a predefined benchmark. Based on the comparison, or ‘ranking’, of the transactional assessment information with the predefined benchmark at block 104, an alert is selectively raised at block 105. Furthermore, the need or preference for any modification of the business transaction prior to the finalisation of the transaction is determined at block 106. If modification is deemed necessary, an opportunity is provided to better align with the predefined benchmark at block 107. Once the transactional assessment information is deemed to rank well compared to the benchmark, or no modifications to the transaction are required, the transaction is finalised at block 108.

### Transactional Data

In some embodiments, block 101 includes the gathering of supporting data for the transaction. For example, this preferably includes data such as the total sale price of the transaction, the total direct costs associated with producing the business activity and the number of units of business activity involved in the transaction. Other information such as the time and date of the particular transaction is also received at this point.

The time for gathering and receiving this data varies depending on the sector of business in which the transaction is to occur. In a retail/wholesale business sector, for example, this information is typically received when an invoice is created following the selection of sale items from an inventory listing by item code or description.

In a typical retail situation, a customer selects one or more items to purchase and bring these items to a register or point of sale (POS). The sales person uses various means to identify and select these items in an electronic inventory system. Such means include, but are not limited to, a laser scanner configured to read in and store data from a unique product bar code, a keyboard connected to a computer system and electronic scales connected to a computer system.

The inventory system contains information relating to each selected item and, in some embodiments, includes information such as the item description, total cost price, cost price per unit (e.g. weight or volume), suggested selling price, tax details, weight, size and other related data.

As each item is added to the transaction, totals are created for total price (excluding tax), total cost and total consumer price (including tax). Preferably the sales person and consumer will only see the total consumer price, a separate tax figure and any other information that is required by law.

In a professional services business sector, the data indicative of a business transaction is typically received when a quotation or invoice is created by a professional. The invoice is generally created by either selecting a template with predetermined descriptions for service or by typing a description of the service. A pre-tax value is then entered or retrieved for that service.

A number of units of business output consumed internally is typically entered or retrieved for that service. For this type of business the units of output are generally the number of hours estimated or “standard” for internal staff to complete the service. The basis for this is often provided by timesheet records and more than one item of service may be entered for the quotation or service.

In some embodiments, external services are also added with or without any margin being added to the price of the item. In these embodiments, both price (excluding tax) and cost values are required.

In the manufacturing sector, the sale of a manufactured item will often include the assembly of sub-items or components. At the lowest level of manufacturing, each item or sub-item incurs a cost of externally sourced material or parts and then a number of units of output are applied to produce the item. Therefore, each component added into a “finished” item, brings with it a cost of materials/parts, a number of units and possibly a sale price.

In some embodiments, particularly those relating to a transaction in the manufacturing sector, externally sourced suppliers (sub-contractors) contribute to an item. In these embodiments, a cost and selling price of each supplier is preferably added into the total for the manufactured item.

When a quotation or invoice is raised for a manufactured item, an aggregate of costs for materials/parts, units of internal output and costs of external suppliers is calculated. The selling price (excluding tax) is then suggested based on this calculation.

In areas of trade and light manufacturing, quotations are commonly provided prior to invoicing and frequently used as a basis of invoicing. In embodiments relating to these business sectors, the sale price net of tax is generally required. The term “net of tax” defines the situation where the items presented in the quote have been adjusted for tax effects.

In some embodiments, data indicative of the costs of supplies, materials, parts and subcontractors are required prior to any tax or sale margin being applied. The number of units of output (usually estimated labour hours) is also typically required.

In the trade and light manufacturing business sector, the method of costing is preferably based on a measure of the time taken to complete the work. However, it will be appreciated that other measures exist. For example, in kitchen cabinet making, the measure of linear metres multiplied by a cost rate is often used to provide a quick quotation. This is based on the assumption that material costs and time required is proportional to the linear size of the cabinet.

In the “service” industry sector, which includes hospitality, transport, hire and communication, a common metric is generally used to obtain and track actual gross profit contribution per unit of activity. For example, a common metric in the restaurant business is the numbers of patrons or meals. For each item on the menu, it is possible to record an estimate of the cost of ingredients so that a gross contribution per patron is available. In this context, the term gross contribution means the sale price minus the cost of ingredients.

### Processing of Transactional Data

As noted above, block 102 provides for processing the data to derive transactional assessment information. In all of the sectors of business outlined above, it is possible to measure the selling price (net of tax), direct costs (of goods/supplies/materials/parts/subcontractors excluding any internal labour costs) and a number of units of business activity. With this data there is basis to calculate the gross profit per unit of activity and the gross profit percent. These are calculated using the following formulas:

Gross profit per unit=(sale price−direct costs)/number of units of activity

Gross profit %=((sale price−direct costs)×100)/sale price

Information such as the gross profit per unit and the gross profit percent are examples of “transactional assessment information”, which, in some embodiments, are used as indicators of the profitability of the business transaction.

For the present purposes, the transactional assessment information is available on any new sale transaction before the buyer is informed of the total sale price and before a quotation is given. For security and confidentiality reasons, the transactional assessment information or certain elements thereof need not be displayed or made available to all staff members.

### Benchmark Comparison

In the present embodiment, the transactional assessment information is compared with a predefined benchmark at block 103. This benchmark can be calculated using an analysis of past transactional data. In particularly preferred embodiments this benchmark is in the form of a projection or financial budget calculated based on a predetermined set of data. In some embodiments this predetermined data is an estimate of the average gross profit per unit and/or an estimate number of units.

The use of past transactional data in calculating a benchmark is particularly useful in the sense that an “on the fly” measure of performance against targets is able to be achieved. For example, the performance of a given transaction is able to be considered in the context of past performance over a given period. In some embodiments a benchmark is adjusted over time as additional transactional data (i.e. new past transactional data) is collected.

In a preferred embodiment, the transactional assessment information, along with any other information associated with each business transaction or invoice, is stored in a database for later analysis. With this information stored and readily available, the possibility exists to create future targets, benchmarks or forecasts of future business activity and productivity. For example, in one embodiment, past invoices are filtered by any number of criteria for any period of time and aggregated to calculate accumulative gross profit information. Such filtering criteria include, but are not limited to, the particular department of the business, the particular sales representative or a particular geographical location.

In one embodiment the benchmark is the ‘target average gross profit per unit of activity’. This is calculated by first subtracting the net of the direct cost of outsourced supplies (e.g. for materials, goods or services) from the period target revenue of a business, division or department of a business. This difference is then divided by the targeted units of invoiced activity for the same period. This measure is a key benchmark against which the gross profit per unit of output can be measured.

An example calculation of the target average gross profit per unit of business activity for an annual projection is set out as follows:

$$\begin{matrix}Desired Net Profit & \$100 \text{,} 000 \\ \begin{matrix}+ total expenses excluding direct cost of \\ goods , materials , parts , suppliers , \end{matrix} & \begin{matrix} \\ \end{matrix} \\ \begin{matrix}subcontractors etc . \\ Target gross profit \end{matrix} & \frac{\$600 \text{,} 000}{\$700 \text{,} 000} \\ \begin{matrix}Targeted activity in units \\ Target average gross profit per unit \end{matrix} & \frac{10 \text{,} 000}{\$70 .00}\end{matrix}$$

In cases where potential activity can be defined such as with labour hours, projected and actual productivity can be calculated and tracked throughout the planning period.

In one embodiment, daily or weekly targets of activity units and average gross profit per unit of activity are developed to reflect trading patterns and market behaviour.

In another embodiment, the actual or estimated productivity or productivity percent is used as a benchmark. In this embodiment, the productivity percent is calculated as follows:

Productivity %=actual or estimated activity in units×100/potential activity in units

In another embodiment, the target number of activity units sold is used as a benchmark. In this embodiment the actual number of activity units sold represents transactional assessment information and is compared to the target number of units to measure the business' productivity. The situation where the actual number of activity units is equal to or greater than the target number of units, is indicative of the business utilizing it's targeted productive capacity.

In another embodiment the benchmark is the actual gross profit per unit achieved for any past period. This particular benchmark is preferably compared to the gross profit per unit of the transaction.

Accumulative comparison of transactional data with target or benchmark data provides a clear indication of the positive or negative impact on the desired target gross profit for the period. This is also helpful in highlighting the level of billable activity or productivity by comparing units sold with units targeted.

### Ranking of Transaction

Following comparison with a benchmark, the transaction assessment data are ranked at block 104. In some embodiments, ranking simply refers to a comparison of actual gross profit per unit with a benchmark. In preferred embodiments, ranking further involves a measure of the degree to which the transaction assessment data is above or below a particular benchmark. This permits the necessity of corrective action to be determined. If corrective action is deemed necessary, guidelines as to the available actions are provided.

In a preferred embodiment, the staff member or sales person handling the transaction is able to view the ranking of the transaction. Preferably the means of viewing the ranking is through an indicator. This indicator is able to be displayed on a computer screen.

In one embodiment, this indicator is a colour bar with colours ranging from red, indicating a ranking below the benchmark, to green, indicating a ranking above the benchmark.

It will be appreciated that further adaptations or other indicators can be used. For example, rankings with a close proximity to the benchmark can be indicated by a white colour on the indicator. Alternatively, the indicator could be of the form of a meter or other software control. In other embodiments, staff members have knowledge of how to interpret the indicator without necessarily knowing the underlying values.

If the transaction is deemed to rank well compared to a benchmark (i.e. satisfy predefined criteria with respect to the benchmark), the transaction is finalised at block 108.

### Raising an Alert

If the transaction is deemed to not rank well compared to a benchmark (i.e. fail to satisfy predefined criteria with respect to the benchmark), an alert is raised at block 105. In a preferred embodiment, this alert is received both at the point of transaction by a person responsible for the transaction (presently assumed to be a staff member), and in some cases additionally at a management level. Preferably the alert is not received by a customer/client. In preferred embodiments, this alert provides recommendations on available options for improving the transaction. In particularly preferred embodiments, these recommendations are arranged in a preferred order for improving the transaction. In other embodiments, this alert simply advises that modification may be required.

In the preferred embodiment, an alert is displayed on a computer screen visible to a staff member, and in some cases additionally on a computer screen visible to management personnel. In other embodiments, an alert is raised by other means such as by email, SMS text message or by sound through a speaker.

Alerts preferably provide information that managers or staff members can use to improve the transaction prior to finalisation. More preferably, the alerts also include information that managers and staff members can use to make future modifications to transactions with the intention of improving future transactions or the long term profitability of the business. For example, the alert may provide suggestive feedback as to how the transaction could be modified prior to finalisation thereby to improve profitability.

### Improving Profitability of Transactions

Once an alert has been raised, a decision is made whether to modify the transaction in order to potentially improve the transaction or better align with the benchmark. This is performed at block 106. In a preferred embodiment, the decision is made by management or staff members. However, in other embodiments, this decision can be wholly or partially made automatically by a computer system depending on the ranking and other data.

If a decision is made to modify the transaction prior to finalisation, an opportunity is provided to modify the transaction at block 107.

To improve or potentially improve a transaction, a number of modifications may be made. Examples of methods that may be used to improve characteristics of a transaction include:

Increase the selling price

Reduce the cost of goods/materials, etc. sold

Substitute higher margin goods by improving product mix

Non-retail, reduce the number of units required by improving efficiency.

Knowingly proceed to gain competitive advantage

Not proceed with the transaction

Some further comments in this regard are provided below.

In one embodiment, the selling price of the business activity may be increased. For example, where a business is underperforming in regards to profit, productivity or otherwise, price adjustment can be used to achieve a better outcome from the transaction.

In another embodiment, the selling price of the business activity may be decreased. For example, where a business is performing better than the target or benchmark, a price reduction can be applied to achieve greater market penetration. This is particularly useful when year to date actual gross profit is ahead of target.

Another modification is to substitute the present business activity for higher margin business activity. For example, in a retail business, an offer or suggestion may be made to the customer to purchase a product where a higher margin exists (noting that this may in some cases be a lower price product).

In some embodiments, when the opportunity to modify the transaction is presented, the decision can be made to simply proceed with the transaction without modification. This option provides the possibility of gaining competitive advantage even at the cost of a below-benchmark transaction.

An option also exists to abandon the transaction. For example, if a customer/client believes that a quoted price is too high, and no other modifications are deemed feasible, then a manager or staff member may decide not to proceed with the transaction.

In other embodiments, modifications such as reducing the cost of goods or materials sold, or reducing the number of units required may be made.

Preferably, combinations of the abovementioned modifications are able to be made prior to finalisation of a transaction. It will be appreciated that other modifications can be made that are more specific to a certain business type or sector.

In some embodiments an automated data driven process is defined thereby to provide suggestive feedback to assist in the identification of one or more potential modifications. For example, appropriate modifications based on particular sets of transactional assessment information are defined at a management level, and maintained in a database, with logic defined for identifying appropriate modifications on the basis of predefined conditions being met by transactional assessment information for a given transaction. From a user perspective, step 107 includes one or more modification from the repository being automatically presented as suggestions. It will be appreciated that this reduces the need for complex decision making at the staff level.

### System-Level Overview

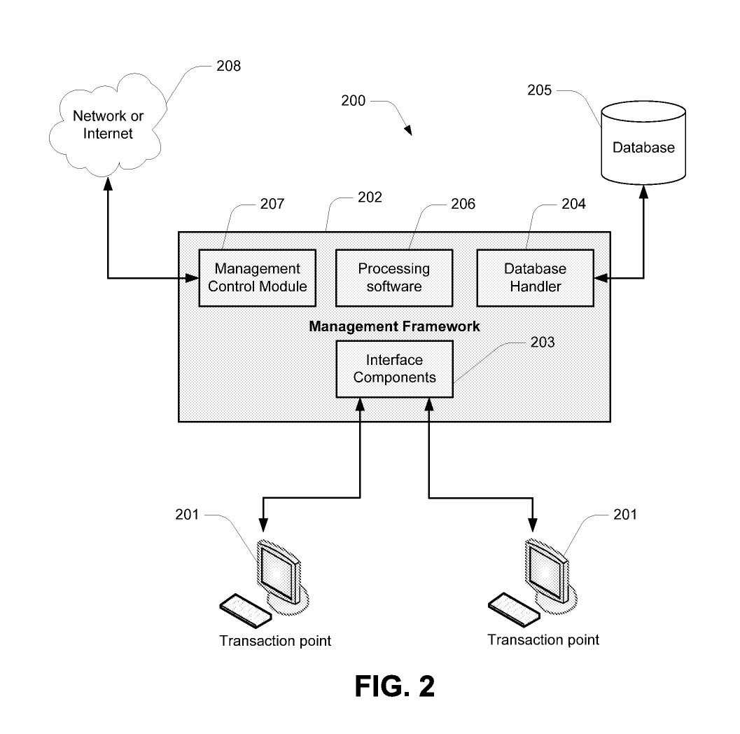

Referring to FIG. 2, one embodiment provides a system 200 for processing transactional data. The system includes at least one transaction point 201 where a business transaction takes place. In one embodiment, this is a POS terminal where customers purchase items and data is acquired by a sales person or staff member. In another embodiment this is an employee's computer where invoices, quotations or cost estimates are produced. Generally speaking, in the context of practical implementation there are a large number of transaction points.

Each transaction point 201 is in communication with a central management framework 202 where the bulk of the data storage processing and control occurs. The management framework is connected to each transaction point through various interface components 203. These components are preferably network interface devices such as ports, network cables, routers, wireless access points and other similar devices. However, it will be appreciated that a variety of other devices can be used for this purpose.

Data such as transaction rankings, alerts, transactional assessment information and data indicative of a business transaction are freely communicated between the management framework 202 and each transaction point 201.

Data indicative of a business transaction that is acquired by a transaction point 201 is handled by a database handler 204 and stored in a database 205. The database 205 is also used to store benchmark and other required data.

In a preferred embodiment, the database handler is a computer server in communication with the data server. However, in other embodiments, the database handler is any computerised system or device capable of managing data. In some embodiments, the database handler performs such tasks as receiving and transmitting data between the database and various other system components, allocating data in the database, overriding undesired data, backing up data and other data management tasks.

The database 205 is any medium or device capable of storing data. For example, a hard disk or drive, CD-ROM, DVD or a solid-state memory device. In some embodiments the database 205 is external to the management framework 202, while in other embodiments this is fully integrated within the management framework.

Data indicative of a business transaction is processed by processing software 206 to derive transaction assessment data. In a preferred embodiment, this transaction assessment data is stored in the database 205 for future analysis and comparison.

In a preferred embodiment, the processing software 206 includes one or more computer programs, applications procedures or functions for deriving the desired transactional assessment information from input business transactional data. For example, a C++ program or a commercial accounting software package.

In some embodiments, the processing software is responsible for ranking the business transaction and raising an alert when the business transaction receives a bad ranking. In other embodiments, these tasks may be performed by other system elements.

The management framework 202 includes a management control module 207 for performing various system changes and updates. This module is in communication with all elements in the management framework as well as external system components such as transaction points 201 and a database 205. In a preferred embodiment, the management control module 207 is a network of personal computers or terminals in communication with each other and the surrounding system. In other embodiments the module is a single personal computer.

In some embodiments, the management control module 207 is responsible for reading or interpreting alerts raised by the processing software 206 and making decisions as to whether to modify the transaction.

The management control module 207 is preferably connected to the internet or other network 208 for interchange of information between management and other outlets, offices and businesses. This is particularly useful where a large business has offices or outlets in several cities and management would like to exchange benchmark, profitability or transactional assessment information.

Connection between the management control module 207 and the internet or network 208 is preferably through a network interface device such as a modem or router. However, a range of other connections are possible.

In other embodiments, elements of the system such as the database 205 and transaction points 201 are in direct connection with the internet for more directly communication with external parties.

### Implementation Options

The above system and method are able to be implemented into a software product which is able to be sold, distributed and integrated into a business' existing hardware or framework.

This software product is able to be installed onto a range of media devices for communication with a computer system. Such media include hard drives, CD-ROMs, DVDs and solid-state media devices such as memory cards and flash drives.

Preferably the media device includes an installation protocol for installing the software onto a business computer system for later use.

### CONCLUSIONS

It will be appreciated that the above system and method provides more accurate and up-to-date measures of profitability and performance. In this regard, current accounting and related software methodology does not compare ‘actual’ business transactional data with ‘target’ data at the point of quoting, pricing or invoicing using gross profit per unit of activity. Comparison of this data, both accumulatively and on an individual transaction basis, allows the actual levels of productivity and profitability to be compared with a benchmark to a greater degree of accuracy.

Furthermore, in most, if not all areas of business activity, the assumptions used to calculate price are not brought forward into an invoice and recorded. This information, available at the point of quoting, pricing or invoicing provides highly relevant, important and unique competitive advantages in profitable decision making.

Comparison of actual gross profit per unit of business activity with a benchmark when quoting, pricing or invoicing provides an almost immediate awareness of whether the actual profit or performance is above or below the benchmark.

The absence of this ‘on-the-go’ comparison does not allow the opportunity to raise an alert in time to take corrective action which may be needed to boost ‘actual’ profits to achieve ‘target’ profits or above.

Depending on the number of transactions, small deficiencies per quote, price or invoice can multiply exponentially over days and weeks with the potential to seriously erode profitability.

In many commercial accounting systems used in business today, the data necessary to assess and compare the ongoing productivity, profitability or business performance already exists or can be readily obtained. For example, the use of computerised inventory or sales systems often includes measures of such data. However, there is currently no system available that can utilize this data to perform these functions ‘on-the-go’ and provide opportunities to take corrective action prior to finalisation of each business transaction. The main reason for this lack of utility of data appears to stem primarily from prevailing accounting theory and methodology.

The technology described herein accounts for such concerns by providing a real-time mechanism for tracking the profitability of transactions, and allowing a feedback loop thereby to assist in managing profitability on an ongoing basis. In particular, by reviewing issues of profitability just prior to the finalisation of a transaction, it is possible to address concerns that may arise without having to rely on a subsequent retrospective analysis.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; a carrier wave bearing a propagated signal detectable by at least one processor of the one or more processors and representing the set of instructions a propagated signal and representing the set of instructions; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method of processing transactional data, including the steps of:
receiving transactional data indicative of a business transaction prior to finalisation of that transaction;
processing the data thereby to derive transactional assessment information indicative of the profitability of the business transaction;
comparing said transactional assessment information with a predefined benchmark; and
based on the comparison of said transactional assessment information with said predefined benchmark, selectively raising an alert, thereby to allow modification of said transactional data such that an opportunity is provided to better align with the predefined benchmark.

2. A method according to claim 1 wherein said transactional data includes a:
total sale price of a business activity;
total direct cost associated with producing said business activity; and
number of units of said business activity.

3. A method according to claim 1 wherein said transactional assessment information includes the gross profit per unit of activity.

4. A method according to claim 1 wherein said transactional assessment information includes the gross profit percentage in combination with gross profit per unit of activity.

5. A method according to claim 1 wherein said benchmark is calculated using past transactional data.

6. A method according to claim 1 wherein said benchmark is a projection or financial budget calculated based on an estimate of the average gross profit per unit and/or an estimate number of units.

7. A method according to claim 1 wherein said benchmark is the ‘target average gross profit per unit of activity’.

8. A method according to claim 1 wherein said benchmark is the target number of activity units sold.

9. A method according to claim 1 wherein said benchmark is the actual gross profit per unit achieved for any past period.)

10. A method according to claim 1 wherein comparing said transactional assessment information with said predefined benchmark includes measuring the degree to which said transaction assessment data is above or below said benchmark.

11. A method according to claim 10 wherein the transaction is ranked based on the degree to which said transaction assessment data is above or below said benchmark.

12. A method according to claim 1 wherein said alert is received both at the point of transaction by a staff member responsible for said transaction and additionally at a management level.

13. A method according to claim 1 wherein said alert is only received by a staff member responsible for said transaction.

14. A method according to claim 12 wherein said alert is displayed on a computer screen visible to said staff member.

15. A method according to claim 14 wherein said alert provides recommendations on available options for improving said transaction.

16. A computer system including a processor configured to perform a method according to claim 1.

17. A computer program product configured to perform a method according to claim 1.

18. A computer readable medium carrying a set of instructions that when executed by one or more processors cause the one or more processors to perform a method according to claim 1.

19.-21. (canceled)
